(19) United States
(12) Patent Application Publication
(10) Pub. No.: US 2013/0071513 A1
(43) Pub. Date: Mar. 21, 2013

(54) BEVERAGE ADDITIVES

(71) Applicant: Kennett Brown Parkes, Nashville, TN (US)

(72) Inventor: Kennett Brown Parkes, Nashville, TN (US)

(21) Appl. No.: 13/424,307

(22) Filed: Mar. 19, 2012

Related U.S. Application Data
(60) Provisional application No. 61/454,239, filed on Mar. 18, 2011.

(51) Int. Cl. A23L 2/60; A23L 2/385; A23L 2/70; A23L 2/39; A23L 2/74; A23L 2/72

(52) U.S. Cl. CPC A23L 2/60; A23L 2/74; A23L 2/72; A23L 2/70; A23L 2/39; A23L 2/385
USPC 426/2; 426/66; 426/548; 426/67; 210/652; 210/767; 210/748.1; 203/10; 426/72

(57) ABSTRACT

We disclose a water-based solution containing xylitol that helps reduce the risk of dental problems. The solution may be pre-packaged in a readably consumable form, or it may be packaged as a concentrate that can be added to beverage at the time of consumption. In addition to xylitol, other additives may be added to the solution including fluoride, flavoring, vitamins, caffeine, carbonation, electrolytes, minerals, sugars, and sugar alcohols.

### FIELD OF THE INVENTION

The subject matter disclosed herein generally relates to a packaged water solution. More specifically, it relates to a packaged water solution comprising substances that may provide dental hygiene and health benefits to a user.

### BACKGROUND OF THE INVENTION

Dental decay is a widespread problem and remains the most common infectious disease for children in the United States. Also, according to the Center for Disease Control, nearly one-third of all adults have some form of untreated tooth decay.

Since at least the 1950s tap water has been treated with fluoride to prevent tooth decay and other dental maladies. However, the efficacy and safety associated with internal consumption of large and unquantifiable amounts of fluoride remains controversial. Some doctors have expressed concerns about adding fluoride to water supplies or allowing young children to drink from such unregulated supplies. Additionally, certain regions, for example Oregon State, do not add fluoride to public water.

On another note, the past several decades have also seen packaged water sales grow dramatically. By some estimates, the global rate of packaged water consumption more than quadrupled between 1990 and 2005. Spring waters and purified tap waters are currently the leading global sellers, but water purified via distillation, reverse osmosis, or other means lacks fluoride ions that are usually present in natural ground waters or public water. It is possible that persistent drinking of distilled, or other treated, water may increase the risk of tooth decay due to a lack of fluoride intake.

### SUMMARY OF THE INVENTION

The subject matter disclosed herein relates to a packaged water solution that may comprise substances that address dental and other health concerns. It is a further object of the invention to provide a packaged water solution that may have an agreeable flavor.

It is a further object of the invention to provide a packaged water solution that provides sufficient levels of desired substances in quantifiable amounts, thereby eliminating the danger of overconsuming substances, such as fluoride, that are present in public drinking water.

It is a further object of the invention to provide a packaged water solution that comprises water, potentially purified by means of reverse osmosis, distillation, desalination, and the like, yet still comprises substances that address dental and other health concerns.

It is a further object of the invention to provide a packaged water solution that comprises substances that may supplement or replace fluoride as a substance that addresses tooth decay and other health concerns.

It is a further object of the invention to provide a packaged concentrate that may be added to water at the time of consumption. The concentrate may be in the form of a flavortab, liquid drops, or a powder.

Also, it is an object of the invention to provide a packaged water solution that is suitable for people of different ages, e.g. adults and children.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

We disclose herein a water-based solution comprising an anti-cavity and anti-plaque purified drinking water suitable for both children and adults. The water solution may be pre-packaged and sold as bottles, or alternatively, the solution may be sold in the form of a concentrate that the consumer may add directly to a container of water.

The water is used as a solvent for the solution. The water may be obtained from a plurality of sources, such as a public water source, a spring, a well, and the like. Furthermore, the water may be treated and/or purified by any method or combination of methods known in the art, including filtration, reverse osmosis, desalination, collection of atmospheric water, and the like. As will be obvious to one of skill in the art, any method of treating and/or purifying water may be used that satisfies the performance criteria of a water solution packager.

In one example embodiment the filtration process comprises one or more activated carbon filters, a reduction filter, and a reverse osmosis filter. Other appropriate filtration systems will be apparent to those of skill in the pertinent arts, and may comprise systems presently in use or other systems conceived in the future.

In one embodiment, water may pass through a reverse osmosis filter so that the water contains only 0.1-3.0 parts per million of dissolved solids. Other purity standards, whether more stringent or less imposing, might also be appropriate.

The solution also contains an additive having beneficial dental benefits. For example, in one embodiment, the formula is prepared by combining a small, predetermined amounts of fluoride, e.g., sodium fluoride (NaF); xylitol (a sugar alcohol); and purified water.

Research into xylitol, a sugar alcohol, has shown that it may have the ability to reduce cavities and plaque, eliminate upper respiratory infections, and more. Its ability to improve dental hygiene may be derived from the inability of bacteria in the oral cavity to digest it and produce lactic acid, an acid that plays a key role in the creation of cavities and the buildup of plaque biofilm.

In a further embodiment, xylitol and/or fluoride may be added to the purified water. In one embodiment, the sodium fluoride may achieve a mixture of approximately 0.7 parts per million fluoride content. This figure is consistent with the current recommended fluoride concentration recommended by the American Dental Association and the Department of Health and Human Services for optimally fluoridated drinking water.

Various embodiments may exhibit a range of fluoride concentrations that may vary from approximately 0.0 to approximately 1.2 parts per million. The eventual fluoride concentration may depend on a variety of factors, including, but not limited to, consumer demand, requests for specific solutions, the intended end users of the solution, formulation and packaging limitations, and current and future health standards.

According to a further embodiment, xylitol may be added to water, either alone or in conjunction with other substances, to achieve a xylitol concentration between around 0.5 g/L to 12.0 g/L. As was the case with fluoride, the specific concentration of xylitol as well as the other chemicals, if any, that are included in the solution may vary in order to obtain a desired substance.

The final solution therefore may comprise an ultra-purified drinking water, which may combine the anti-cavity properties of fluoride with the anti-plaque and anti-cavity properties of xylitol, all within strictly controlled and regulated ranges. Other embodiments may only contain xylitol or xylitol in combination with other desirable substances, fluoride excluded. Solution compositions may differ if, for example, different population segments are targeted. For example, one embodiment comprises a solution with xylitol and fluoride and is targeted toward children, whereas a xylitol only solution may be desired for adult consumption.

In addition to xylitol, other sugar alcohols may also be used in the solution. For example, erythritol, is a sugar alcohol that is known to be non-caloric, and to not contribute to tooth decay.

Similarly, stevia may be used in the solution to add sweetness to the beverage if a low-carbohydrate or low-sugar alternative is required. In one embodiment, coconut palm sugar may be used as an alternative to sugar.

Of particular interest is that embodiments of the invention may be capable of delivering proper and predetermined levels of xylitol, alone or in combination with other substances, to users. The disclosed invention may additionally include additives to improve the flavor of the solution or to otherwise produce desired health benefits. For example, it may include additional flavors, vitamins, caffeine, electrolytes, minerals, and carbonation. Prior art compositions and methods, such as gums and nose sprays, lacked the ability to supply sufficient levels of xylitol to a user in order to have positive effects on dental hygiene. Also, it should be noted that the current formula may ameliorate dental hygiene, upper respiratory infections, and other medical maladies.

Also, embodiments of the present invention may be formulated so that the end product has positive effects on hygiene and other maladies, and also has a pleasant taste. By making a water solution with certain compositional concentrations, including those discussed above, the end product may serve as a traditional hydrating beverage, albeit one with beneficial medical effects. This dual-use and the ability to be pleasant tasting to an end user is not available in many other dental and/or xylitol products. The end product may also have the unexpected result of being a sweetened water supplement, providing not only the health benefits associated with lower sugar intake, but also those associated with xylitol and/or fluoride intake.

It should be appreciated that the solution may be presented as a concentrate that can be added to a container of water. For example, a concentrated solution in the form of liquid droplets may be added directly to the water by the consumer. This allows the consumer to carry the concentrate in a convenient manner, such as in a pocket or purse, and add it to a beverage at their convenience. The concentrate may also be in the form of a tablet, or powder that may be dropped into the beverage and brought into solution by stirring or agitation.

This concentrated form may include additional additives as well, including fluoride, flavoring, vitamins, caffeine, carbonation, electrolytes, minerals, sugars, and sugar alcohols.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A packaged water solution, comprising: purified water and xylitol.

2. The solution of claim 1, wherein the water is purified by means of reverse osmosis, filtration, UV radiation, collection of atmospheric water, and/or distillation.

3. The solution of claim 1, further comprising fluoride.

4. The solution of claim 3, wherein fluoride is present in concentration of about 0-1.2 ppm.

5. The solution of claim 1, wherein xylitol is present in concentrations of about 0.5-12.0 g/L.

6. The solution of claim 1, further comprising a sugar alcohol.

7. The solution of claim 6 wherein said sugar alcohol is erythritol.

8. The solution of claim 1 further comprising an at least one additive selected from the list including fluoride, flavorings, vitamins, caffeine, carbonation, electrolytes, minerals, and sugars.

9. A method of using the solution of claim 1.

10. A concentrate for adding to a beverage comprising xylitol.

11. The concentrate of claim 10 further comprising an at least one additive selected from the list including fluoride, flavoring, vitamins, caffeine, carbonation, electrolytes, minerals, sugars, and sugar alcohols.

12. The concentrate of claim 10, wherein said concentrate is in the form a powder that can be mixed with water.

13. The concentrate of claim 10, wherein said concentrate is in the form of a liquid that can be mixed with water.
